(19) United States
(12) Patent Application Publication
(10) Pub. No.: US 2008/0011841 A1
(43) Pub. Date: Jan. 17, 2008

(54) System and Method of Detecting Product Code Duplication and Product Diversion

(75) Inventors: Matthew SELF, Emerald Hills, CA (US); Elliott Grant, Redwood City, CA (US)

Correspondence Address: GREENBERG TRAURIG, LLP (SV);IP DOCKETING, 2450 COLORADO AVENUE, SUITE 400E, SANTA MONICA, CA, 90404, US

(73) Assignee: YOTTAMARK, INC., Redwood City, CA (US)

(21) Appl. No.: 11/770,567

(22) Filed: Jun. 28, 2007

Related U.S. Application Data
(63) Continuation-in-part of application No. 11/347,424, filed on Feb. 2, 2006.
(60) Provisional application No. 60/650,364, filed on Feb. 3, 2005.

(51) Int. Cl. G06K 19/06

(52) U.S. Cl. 235/385; 235/494

(57) ABSTRACT

Systems and methods for detecting product code duplication and product diversion are disclosed herein. One embodiment includes generating a plurality of product codes, each product code being unique for each separate item of a set of items, recording a quantity of authentication requests for a product code of the plurality of product codes, and in response to the quantity of authentication requests for the product code matching or exceeding a predetermined threshold, identifying the product code as a suspected duplicated. One embodiment includes recording locations of items of the set of items based on geographical data associated with authentication requests of the plurality of product codes associated with the set of items, in response to identifying a pre-identified quantity or percentage of the items record locations different from pre-identified destination of the respective items, identifying one or more of the product codes to determine if one or more of the corresponding items have been diverted.

### CROSS-REFERENCE TO RELATED APPLICATIONS

This application is a continuation-in-part of U.S. patent application Ser. No. 11/347,424, filed Feb. 2, 2006 entitled “Method and System for Deterring Product Counterfeiting, Diversion, and Piracy,” which claims priority to U.S. Provisional Patent Application Ser. No. 60/650,364, filed Feb. 3, 2005 entitled “System, Method and Technique for Combating Product Counterfeiting, Piracy and Diversion.” The disclosures of the above-referenced applications are incorporated herein by reference.

### TECHNICAL FIELD

The present disclosure relates generally to a method and system of detecting product code duplication and product diversion for product tracking purposes.

### BACKGROUND

The advancement of technology has encouraged and facilitated product counterfeiting. Product counterfeiting may encompass marketing impure jewelry products, brand-naming generic drugs/non-approved drugs, counterfeiting medicine, and/or brand-naming generic soda. Certain situations result in monetary loss whereas in some situations, lives may be at stake, such as a non-approved drug of unknown origin causing unexpected reactions.

While unique product codes for each item can facilitate identification and authentication of an individual item, it is conceivable that the unique product codes be copied and marked on counterfeit products. Since valid codes cannot be generated by a counterfeiter, by copying codes onto products, a valid authentication result can be obtained. Copied product codes will potentially compromise the integrity of the product code authentication system and may result in counterfeit products to be undetected and cause immeasurable harm to end users.

Furthermore, different countries also have different export and import control regulations. Imports of certain products may be regulated and/or prohibited. To circumvent import/export controls and/or taxation issues, products may be disguised and packaged as an alternate product with more lenient regulations and/or lower taxes before shipment across foreign borders. Products may also be diverted from their original destination, often in violation of commercial contracts. Product diversion may also significantly impact government tax revenues. The ability to track and monitor distribution of sensitive items (e.g., weapons, drugs, alcohol, medication, etc.) is also compromised.

### SUMMARY OF THE DESCRIPTION

Methods and systems for detecting product code duplication and product diversion for product tracking purposes are described herein. Some embodiments of the present disclosure are summarized in this section.

One embodiment includes generating a plurality of product codes, each product code being a unit level code that is unique for each item for a set of items, recording a quantity of authentication requests for a product code of the plurality of product codes, and in response to the quantity of authentication requests for the product code matching or exceeding a predetermined threshold, identifying the product code as a suspected duplicated. One embodiment includes recording locations of items of the set of items based on geographical data associated with authentication requests of the plurality of product codes associated with the set of items, in response to identifying a pre-identified quantity or percentage of the items record locations different from pre-identified destination of the respective items, identifying one or more of the product codes to determine if one or more of the corresponding items have been diverted.

The present disclosure includes methods and apparatuses which perform these methods, including processing systems which perform these methods, and computer readable media which when executed on processing systems cause the systems to perform these methods.

Other features of the present invention will be apparent from the accompanying drawings and from the detailed description which follows.

### BRIEF DESCRIPTION OF THE DRAWINGS

The disclosure is illustrated by way of example and not limitation in the figures of the accompanying drawings in which like references indicate similar elements.

FIG. 1 illustrates an example of a consumer device and/or a client communicating with a server module to access product information coding and authentication services, according to one embodiment.

FIG. 2A is a flow chart describing an overview of an example process of product code request, according to one embodiment.

FIG. 2B is a flow chart describing an overview of an example process of product code authentication request, according to one embodiment.

FIG. 3 is a flow chart describing an overview of an example process of a product code authentication request to provide additional product information, according to one embodiment.

FIG. 4 is a flow chart describing an overview of an example process of a product code authentication request to detect product diversion, according to one embodiment.

FIG. 5 is a flow chart describing an overview of an example process of a product code authentication request to detect product code duplication, according to one embodiment.

FIG. 6A illustrates an example of an alphanumeric representation of an encrypted product code, according to one embodiment.

FIG. 6B illustrates an example of an alphanumeric representation of an encrypted product code encoded as a graphic symbol, according to one embodiment.

FIG. 7A is an exploded view of a server module, according to one embodiment.

FIG. 7B illustrates a block diagram having sources for a set of instructions, according to one embodiment.

FIG. 8 illustrates a screen shot showing one embodiment of a web interface for entering data identifying a batch of product codes.

FIG. 9 illustrates a screen shot showing one embodiment of a web interface for generating of a set of product codes based on the batch information that was entered in the screenshot of FIG. 8.

FIG. 10 illustrates a screen shot showing one embodiment of a web interface to verify authenticity of a product code.

FIG. 11 illustrates a screen shot showing one embodiment of a web interface having the results from verifying authenticity of the product code entered in the code field of FIG. 10.

FIG. 12 is a block diagram of a product code during a process of product code generation and encryption, according to one embodiment.

FIG. 13 is a block diagram of a product code during a process of product code decryption and authentication, according to one embodiment.

FIG. 14 is an example conversion table for mapping between encrypted product codes and a corresponding alphanumeric representation, according to one embodiment.

### DETAILED DESCRIPTION

At least some embodiments of the disclosure relate to a method and system of detecting product code duplication and product diversion for product tracking purposes.

The following description and drawings are illustrative and are not to be construed as limiting. Numerous specific details are described to provide a thorough understanding of the disclosure. However, in certain instances, well known or conventional details are not described in order to avoid obscuring the description. References to one or an embodiment in the present disclosure can be, but not necessarily are, references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Embodiments of the present disclosure include methods and systems of detecting product code duplication and product diversion for product tracking purposes. In one embodiment, a method includes generating a plurality of product codes, each product code being a unit level code that is unique for each item based on receiving a request to generate the plurality of product codes. The request may be generated anywhere in a product supply chain by a client (e.g., a company, a manufacturing division of a company, a packaging site, etc.). For example, the request for a set of product codes may be generated during a manufacturing process for individually labeling a batch of items for tracking purposes; the request may also be generated during the packaging process prior to shipment.

Product Diversion

In one embodiment, information regarding each authentication request is recorded to track potential product code duplications and/or product diversions. Information such as the identity of the code authentication requester, the location of the authentication request, the time of the request, or the frequency of the request for a particular product code, etc. are recorded. In one embodiment, locations of items of the set of items based on geographical data associated with authentication requests of the plurality of product codes associated with the set of items, and in response to identifying a pre-identified quantity or percentage of the items record locations different from pre-identified destination of the respective items, identifying one or more of the product codes to determine if one or more of the corresponding items have been diverted.

Although a few products may be transported or resold by customers after initial purchase, a large number of authentications in unanticipated locations may indicate product diversion in the supply chain and should be reported since diversion is typically in violation of commercial contracts and may be an indicator of theft, tax evasion or other illegal behavior.

Therefore, the pre-identified destination of the items can be recorded when the products are manufactured, if known, or added at a later time after shipment. The pre-identified destination can be a continent, a country, a state, a city, a town, a street, or an address of a store/business/residence. When a product code is being authenticated, the location of the authentication can be recorded based on the geographical data associated with the authentication request In one embodiment, the geographical data can be a zip code, a country code, an area code, an IP address, a telephone number, GPS data, a satellite image, or a physical address associated with the authentication request. For example, the geographical data can be determined from at least one of an identity of an authentication requestor, registration information of a requesting device with a service provider, a unique identifier of the authentication request, or a unique identifier of the requesting device.

In one embodiment, the location of the authentication request is compared to the pre-identified destination (or a location on the intended route to destination) to detect diversion of the item. The item can be reported in response to the recorded location of the item not matching the pre-identified location occurring a number of times matching or exceeding a predetermined threshold. A particular manufacturing lot or shipment of the associated diverted item may also be reported.

Code Duplication

Since unique product codes are generated and to be marked on each individual item or package to authenticate the individual item or package, counterfeiters cannot generate product codes that can be authenticated due to the encryption algorithm used for product code generation. Therefore, counterfeiters may copy a product code from an authentic product and reproduce the copied product code to be marked on counterfeit products. In one embodiment, a quantity of authentication requests of a product code of the plurality of product codes is recorded to identify potential duplication of the product code to be printed on an inauthentic item.

Therefore, duplicate authentication attempts for a product code is detected and recorded since duplicate authentications may indicate a copied product code on counterfeit products. In one embodiment, the quantity of authentication requests for a product code of the plurality of product codes is recorded. If the quantity of authentication requests for the product code matches or exceeds a predetermined threshold, the product code is selected to determine if the product code has been duplicated, and the relevant procedures are taken and the relevant personnel is notified.

Providing Product Information with Authentication

The system can be configured to return product information about the product that is being authenticated. In one embodiment, when a request for the plurality of product codes is received, product information associated with the plurality of product codes of a plurality of items is recorded and maintained. The product information can be provided when the request is sent, prior to sending the request, or after the request has been sent.

For example, product information can be supplied when the client engages in the services of the code providing entity. Additional information may be supplied at the time services are rendered (e.g., when a batch of product codes is requested). For clients with a diverse product line, product information may be supplied at the time of the request for the plurality of product codes. Furthermore, additional product information may be supplemented after product codes for the items have been generated. For example, product defects detected after manufacturing and packaging can be supplied to the code providing entity. Upon authentication, defect information can be provided to an end user.

In one embodiment, product information is maintained and organized upon receipt for the plurality of items and the product information is also associated with the plurality of product codes generated for the plurality of items. As such, the product information associated with the product code of the item can be identified in response to receiving a request to authenticate the product code. During authentication, it is determined whether the product code is one of the generated product codes.

The plurality of product codes may be generated by the code service provider or by the client at a client site, according to one embodiment. The plurality of product codes generated at the site of the code service provider can be sent to the client site over a secure network. In addition, the product codes can be generated at the client site where key information (e.g., encryption key) used to generate product codes is provided over a secure network to the client by the code service provider.

Marking Product Codes

In one embodiment, the plurality of product codes are marked onto product labels upon receipt where each unit item has a different product code. The product codes can be marked onto the products at the site of the coding service provider, or the product codes can be marked onto the products at the client site.

In one embodiment, the product codes are marked with any type of printing system suitable for printing product codes on products, labels and/or product packaging. For example, the printing device used may be a high-speed industrial inkjet printer (with visible or invisible ink), a thermal transfer printer, and/or a laser marker, etc. In some embodiments, special invisible inks may be utilized to covertly mark products with invisible codes. The product code may uniquely identify a product or a class of product. In one embodiment, the product code is marked as a bar code and the information is retrieved from the computer system by reading the bar code with a camera phone.

Code Generation and Authentication

In one embodiment, each product code generated is unique for a separate unit item, and a subsection of the product code includes a check value. The batch of product codes may be generated based on data received from the client (e.g., the company). The data sent by the client may include time and date of manufacture, product code (e.g., UPC code), manufacturing plant, a product description, a package size or quantity, a packaging image, a work order, a lot number, an expiration date, operator name, and/or production line, etc. In one embodiment, a portion of the product code may be a check value that is validated during a decryption process to determine authenticity of the product through comparing the check value to a value (e.g., a constant value for a batch) to authenticate the product code.

According to one embodiment, in response to receiving a request to authenticate a product code, the product code is decrypted using a key. The key is identified by an identifier included in the product code. Once decrypted, a check value is identified from the product code after decryption. The check value is then compared to a constant (e.g., predetermined) value to authenticate the product code. In another embodiment the product code does not include a key identifier to identify the encryption key. Rather, the same key can be used for every product code that is generated and every product code can be decrypted with the same key. Alternatively, a set of keys may be used to generate a set of product codes. Rather than using a key identifier to determine the key used, each key of the set of keys is used during the authentication process to decrypt the product code received in an authentication request until the expected check value is yielded from one of decoded results. If none of the keys can decrypt the product code and yield an expected check value, the product code is determined to be inauthentic.

In one embodiment, the check value is compared to a predetermined value to authenticate the product code associated with a particular product (or item). If product code authentication fails, the client (e.g., the company) can be notified such that appropriate actions (e.g., product recall, product tracing, manufacturing changes, etc.) can be taken.

The request to authenticate the product code can be generated anywhere along the supply chain. For example, the request to authenticate a product code can be generated by a consumer during a shopping session prior to purchasing the item, by a clinician when a medical product is to be used, by a distributor prior to product shelving, and/or by the consumer when the product is to be used/consumed. Additional product information about the product associated with the product code being authenticated can also be provided to the requester during authentication of the product code. The additional product information provided may also depend on an identity of the code authentication requester. For example, the identity of the code authentication requester can be one or more of a customs officials, supply chain personnel, end consumers, and retailers.

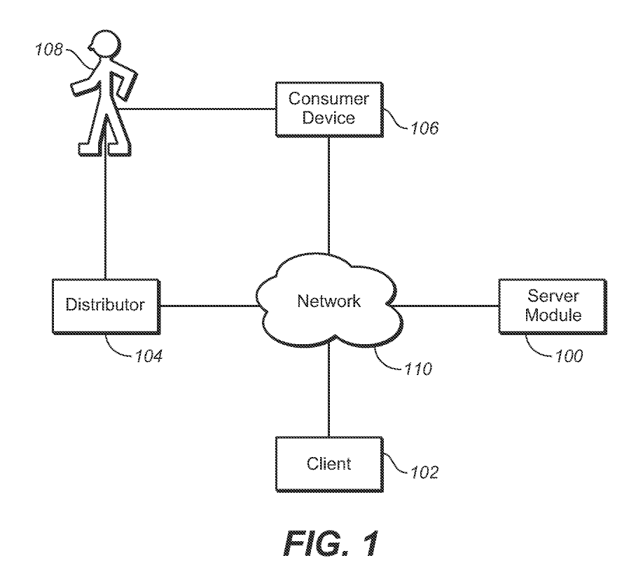

FIG. 1 illustrates an example of a consumer device 106 and/or a client 102 communicating with a server module 100 to access product information coding and authentication services through a network 110, according to one embodiment.

The server module 100 may be operated by an entity that offers product information coding and authentication services to one or more clients 102. For example, the client 102 having multiple manufacturing and/or packaging sites may be serviced by a server module 100 at each site, as needed. Alternatively, the server module 100 may service a variety of clients 102 associated with different companies having similar or different products. The server module 100 may also service various sites of the same company.

In one embodiment, the server module 100 may maintain client information such as product lines, manufacturing sites, and/or dates of production associated with a particular batch request to be associated with management of client specific encryption/decryption keys. In one embodiment, each client 102 has a unique key. In alternate embodiments, unique keys may be assigned to each product line for the client 102, a new key can be generated periodically for each client 102, or a new key is generated based on frequency of usage by the client 102. In addition, a different key may also be associated with products manufactured from a different manufacturing site of the client 102. In an alternate embodiment, each client uses the same encryption/decryption key.

In one embodiment, a set of unique product codes having a common check value as a section of the product code is generated and the set of unique product codes can be authenticated by comparing the check value section of the product code to the check value which is a constant value for the product codes for a batch.

The network 110, over which the client 102, the consumer device 106 and the server module 100 communicate, may be an open network, such as the internet, or a private network, such as an intranet. In one embodiment, communications to and from the server module achieved by a means of secure communications protocol, such as secure sockets layer (SSL), or transport layer security (TLS).

The client 102 may be any of the various facilities of an organization involved in the process of delivering a product to the marketplace. Based on specific business processes and product delivery procedures of the particular organization, the client 102 may be integrated where suitable in the production line.

For example, the client 102 may be employed during manufacturing, prototyping, packaging, and/or distribution. The client 102 may also be employed at a combination of facilities as necessary and communicating a request to the server module 100 for a set of product codes to be placed on the product. In one embodiment, information regarding the product and/or the company itself may be sent to the server module 100 along with the request for product codes to be encoded in the product code such that information about the product can be revealed to a relevant party (e.g., a consumer or a distribution center, a customs officer, etc.) when the product code is decoded to be authenticated. In an alternate embodiment, product information may be associated with the generated product codes and provided to the code authentication requestor. The product information provided to the code authentication requestor may be dependent on the identity of the code authentication requestor.

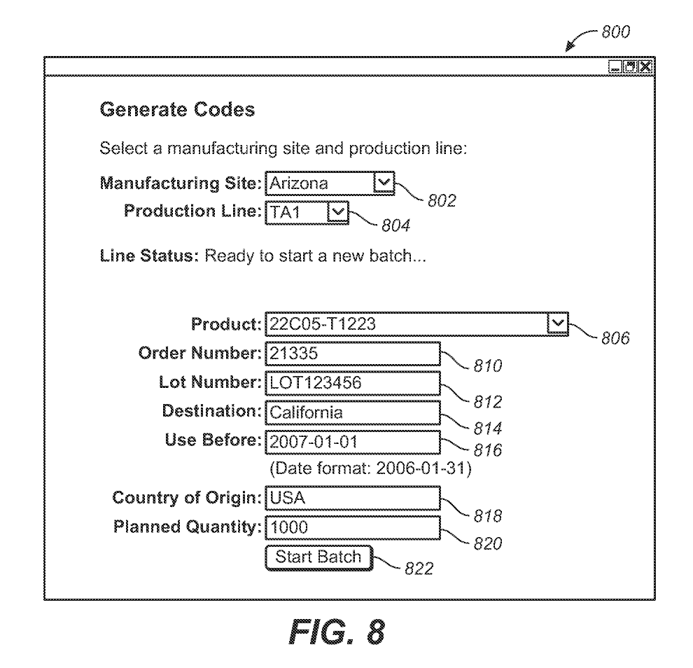

For example, FIG. 8 illustrates a screen shot 800 showing one embodiment of for entering data identifying a batch of product codes. The data entered can be associated with the generated product codes and can be provided to a product code authentication requestor. In one embodiment, the data entry fields include a manufacturing site drop down box 802, a production line drop down box 804, a product selection drop down field 806, a order number field 810, a lot number field 812, a destination field 814, an expiry date field 816, a country of origin field 818, and a field indicating planned quantity 820 of product codes to be generated. The batch information can then be submitted to the server module 100 when the ‘start batch’ button 822 is activated for product code generation by the server module 100. Less than all of these features could be included, or alternative features could be included.

Batch information can be submitted through a web interface 800 to the server module 100 which generates a set of product codes based on the batch information and returns the set of product codes to the client 102. The set of product codes can also be marked directly on products. In one embodiment, product code generation capabilities reside on the client 102 and the web interface 800 is utilized to generate a batch of product codes at the client 102 site with an encryption key received from the server module 100 and stored at the client 102 site.

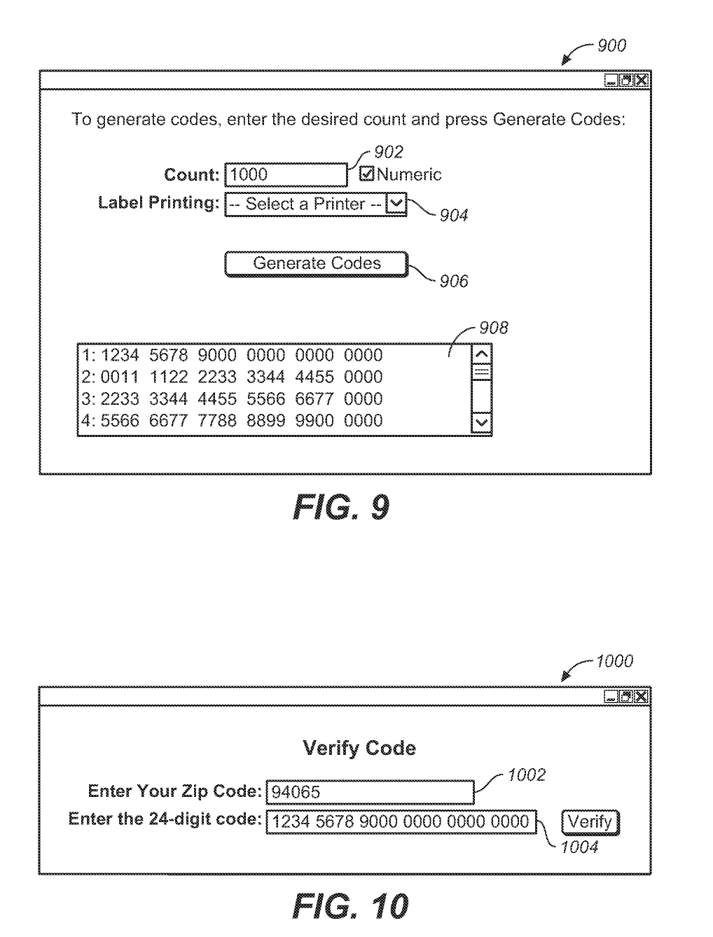

Furthermore, FIG. 9 illustrates a screen shot 900 showing one embodiment for requesting generation of the set of product codes based on the batch information that was entered in the screenshot 800 of FIG. 8. For example, the number of product codes to be generated can be entered in the count field 902, and a printer can be selected in the printer field 904 to be used to mark the set of product codes on products. In one embodiment, when the generate product codes button 906 is selected, a set of product codes for the respective batch is generated by the server module 100 and displayed in the display box 908. The client 102 can receive the generated product codes on the screen as shown. In one embodiment, the product codes can be directly sent to a marking system to be placed and applied to products. In one embodiment, the product codes are generated at the client 102 site with an encryption key assigned by the server module 100.

The consumer device 106 may be any device having networking capabilities (e.g., mobile phone, PDA, notebook, desktop computer, etc.) able to send a product code that is to be authenticated through the network 110 to the server module 100. For example, the consumer device 106 may be operated by a store manager, a supply manager of a medical clinic, a consumer at a shop, a user of a product to determine authenticity of the product code corresponding to a particular product to verify the product origin and to detect counterfeits.

The product code may be captured by the consumer device 106 in various methods including keyed entry from a keyboard, a telephone keypad, a camera, and/or a bar code reader and sent to the server module 100 for validation. In one embodiment, the product code may be sent via email, text messaging, and telephonic capabilities of the consumer device 106 to the server module 100 for authentication. In another embodiment, the product code may be authenticated via a webpage access of data maintained by the server module 100 to locate information associated with the product having the particular product code. Furthermore, the product code can be represented by a bar code that is scannable by an image capturing device. The scanned image can then be sent over the network to the server module 100 for authentication.

For example, FIG. 10 illustrates a screen shot 1000 showing one embodiment of a web interface to verify authenticity of a product code. In one embodiment, the zip product code of a location of authentication can be entered in the zip code field 1002 and the product code can be entered in the code field 1004. Once the verify button is activated, the information entered can be used to locate information associated with the product code entered in the code field 1004 and authenticity of the product code is determined by the server module 100. In one embodiment, the zip code of location of authentication is used by the server module 100 to track usage of generated product codes for duplication detection and to track destination of products. In addition to communicating authentication results to the consumer device 106, alternate information revealed during the decryption process, such as product information, expiration date, manufacturing location, may also be communicated to the consumer device 106 and displayed accordingly.

In other embodiments, geographical data such as a country code, an area code, an IP address, a telephone number, GPS data, a satellite image, or a physical address associated with the authentication request can be used to determine the location of a product. For example, the geographical data can be determined from an identity of a requestor such as a customs official of a particular country. The geographical data can also be determined from information supplied by a service provider such as servicing region, rate structure, phone number of caller, etc. Furthermore, the geographical data can be manually supplied with the request such as entering the zip code of the location of authentication or sending GPS data of the requesting device with the authentication request. Alternatively, a unique identifier of the authentication request or the requesting device may be used to track a location of the item (product) authenticated.

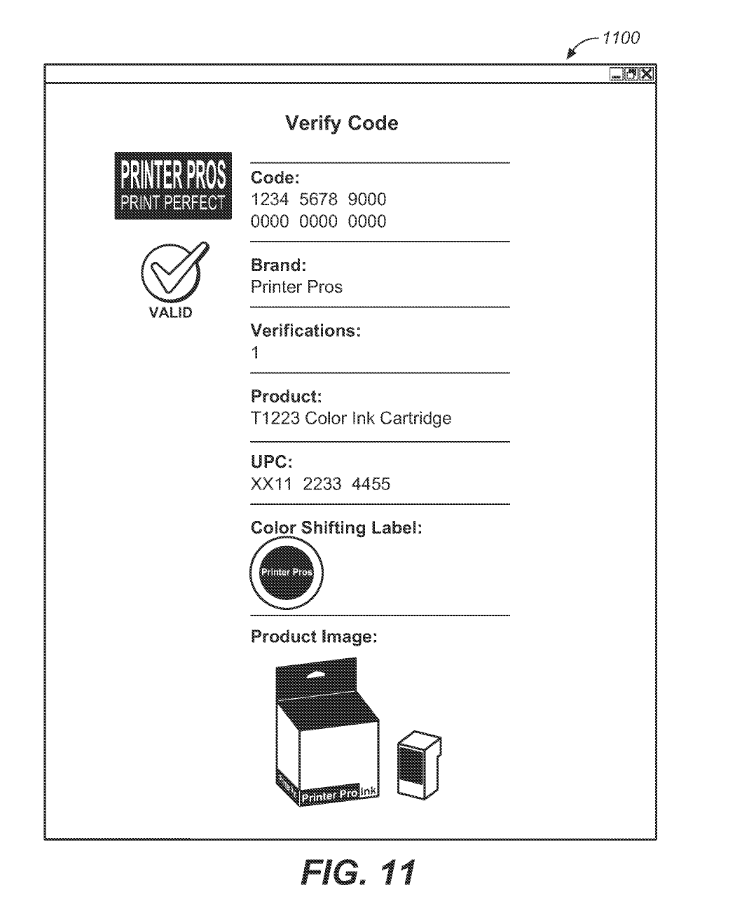

For example, FIG. 11 illustrates a screen shot 1100 showing one embodiment of a web interface having the results from verifying authenticity of the product code entered in the code field 1004 of FIG. 10. In this example, the product code was determined to be valid as indicated by a check mark icon labeled ‘valid’. Furthermore, product information including the brand, type of product, UPC code is also determined and displayed on the verification screen. In one embodiment, a product image is also displayed. In another embodiment, the number of times this product code has been verified is also reported to detect potential duplicate product codes. Also included is the image of the color shifting label, which is a secondary security feature of the product.

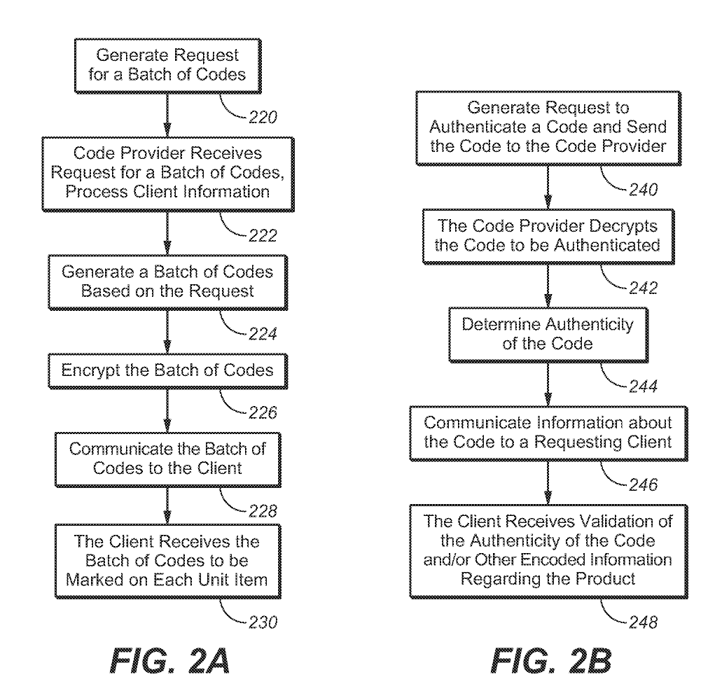

FIG. 2A is a flow chart describing an overview of an example process of product code request, according to one embodiment.

In operation 220, a request for a batch of product codes is generated. In one embodiment, the request may also include relevant product information and/or client information. In operation 222, the code provider receives the request for a batch of product codes and processes the client information, in one embodiment. In operation 224, the batch of product codes is generated based on the request including client information and/or relevant product information. The batch of product codes may be generated at the client site or at the code provider site. In operation 226, the batch of product codes is encrypted. In operation 228, the batch of product codes is communicated over a secure network to the requesting client if the product codes are generated at the code provider site. Alternatively, the requesting client may instead receive key information from the code provider to generate product codes on site. In operation 230, the client receives the batch of product codes to be marked on each unit item, if the code provider generated the product codes.

FIG. 2B is a flow chart describing an overview of an example process of product code authentication request, according to one embodiment.

In operation 240, a request to authenticate a product code is generated. In one embodiment, the product code is sent to the code provider. In operation 242, the product code to be authenticated is decrypted (by the product code provider). In one embodiment, the code authentication is performed by the code provider. In alternate embodiments, the code authentication can be provided by an organization authorized by the code provider. In operation 244, authenticity of the product code is determined. In operation 246, the information about the product code is communicated to the requesting client. In operation 248, the client receives validation of the authenticity of the product code and/or any other encoded information regarding the item.

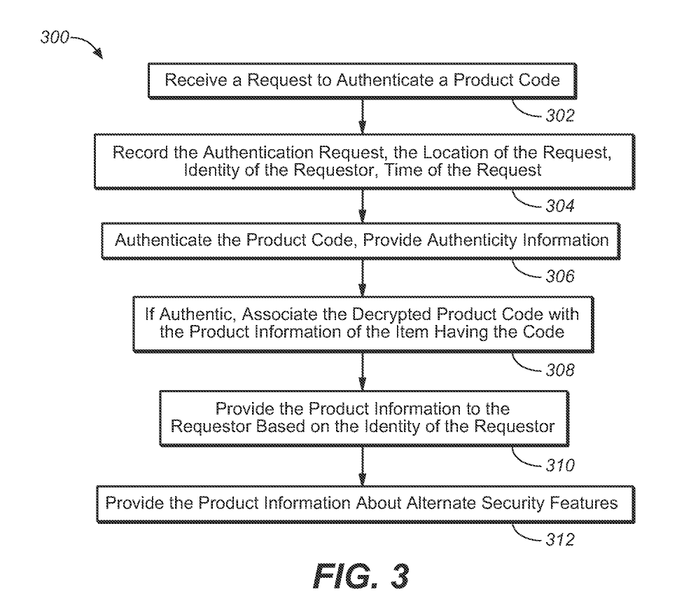

FIG. 3 is a flow chart 300 describing an overview of an example process of a product code authentication request to provide additional product information, according to one embodiment.

In process 302, a request to authenticate a product code is received. The request and the product code can be transmitted through a network via a image capturing device. The request and the product code can also be manually entered with a keyboard, a telephone or a cell phone and sent via email, SMS, telephone call, and or through web submission. In one embodiment, the product information associated with the product code to be authenticated can be retrieved via web access through a web interface. Alternatively, the product information associated with the product code is retrieved manually.

In process 304, the authentication request is recorded along with other relevant information such as the location of the request, an identity of the requestor, and/or the time the request occurred. For example, locations of items of the set of items are recorded based on geographical data associated with authentication requests of the plurality of product codes associated with the set of items. In process 306, authenticity of the product code is determined and the validity of the code is provided to the requestor.

The authenticity of the product code can be determined from any suitable encoding/decoding algorithm. In one embodiment, the product code is decoded with a triple DES encryption/decryption algorithm with a encryption/decryption key that is maintained confidential. In process 308, if the product code is determined to be authentic, product information associated with the product code is identified in client records.

In process 310, all or part of the product information is provided to the requester based on the identity of the requester. The product information may include time and date of manufacture, product code (e.g., UPC code), manufacturing plant, a product description, a package size or quantity, a packaging image, a work order, a lot number, an expiration date, operator name, a pre-identified destination, and/or production line, etc. For example, the product information provided to a customs official may include taxation records for imported goods. The product information provided to a law enforcement official may include a shipment history of the item/package.

The product information can also include details of security features of the item in addition to the product code, including holograms, color-shifting inks, taggants, micro-texts, intaglio ink, magnetic ink, or up-shifting phosphors, etc. These security features may be difficult to identify due to their covert nature. By providing information regarding these security features, customs and/or law enforcement officials will know where to locate these features and how to interpret them. In process 312, information about security features is provided to the requester.

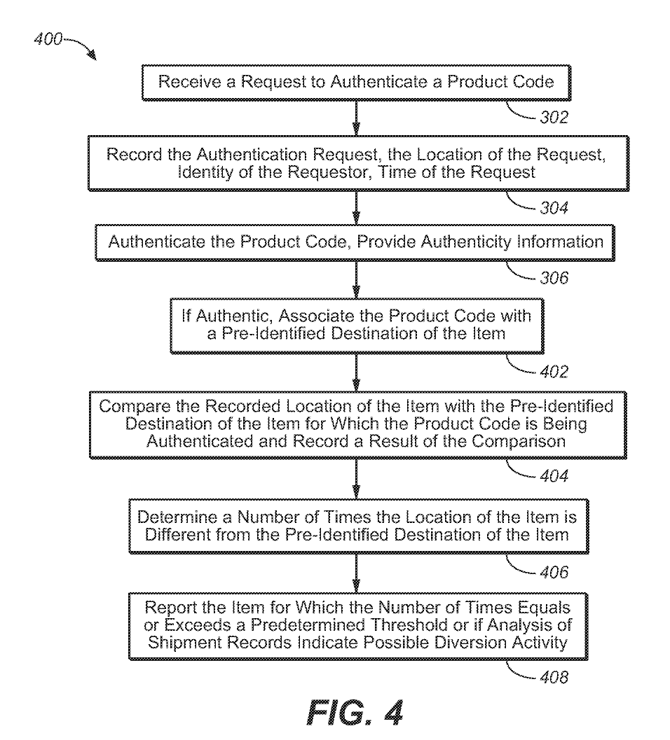

FIG. 4 is a flow chart 400 describing an overview of an example process of a product code authentication request to detect product diversion, according to one embodiment.

After a product code has been authenticated, the product code is associated with the pre-identified destination of the item or package in process 402. In one embodiment, the destination is one or more of a continent, a country, a state, a city, a province, country, a street, a home address, and/or a business address.

In process 404, the recorded location of the item is compared with a pre-identified destination of the item for which the product code is being authenticated and a result of the comparison is recorded. In addition, in response to identifying a pre-identified quantity or percentage of the items record locations different from pre-identified destination of the respective items, identifying one or more of the product codes to determine if one or more of the corresponding items have been diverted.

The recorded result can indicate whether the recorded location matches the intended location. The location of the item can be determined based on geographical data associated with the authentication request, such as a zip code, a country code, an area code, an IP address, a telephone number, GPS data, a satellite image, or a physical address. The geographical data can be determined from one of a group comprising an identity of an authentication requester, a location of the authentication request, account information of a requesting device with a service provider, a unique identifier of the authentication request, or a unique identifier of the requesting device.

In addition, the distance between the pre-identified destination and the recorded location of the item can be determined. Authentications that may occur while the item is en route to its destination is also taken into account by associating the route to destination with the product information.

In process 406, a number of times the location of the item is different from the pre-identified destination of the item is determined. For example, recorded locations of authentication that are en route to the destination will not be counted against a predetermined threshold beyond which diversion is suspected. In addition, re-sales (e.g., yard sale, eBay, Amazon sales) by the original owner may also result in authentication location different from the intended location.

In one embodiment, the location records are also analyzed based on other criterion that would deem a shipment illegally diverted. For example, individual items may be resold to other locations and should not be considered product diversion. However, a large number of items authenticated in an unanticipated location may indicate that the associated products have been diverted in the supply chain.

In process 408, the item for which the recorded location of the item not matching the pre-identified location occurring a number of times matching or exceeding a predetermined threshold is reported. In an alternate embodiment, if the analysis of shipment records imply suspected diversion activity based on criterion other than the number of times of unexpected item location, a report is also generated.

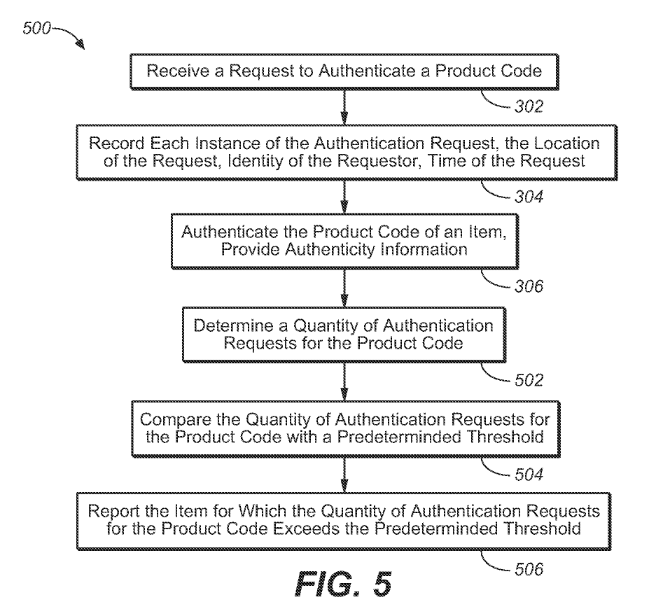

FIG. 5 is a flow chart 500 describing an overview of an example process of a product code authentication request to detect product code duplication, according to one embodiment.

After a product code has been authenticated, a quantity of authentication requests for the product code is determined and recorded in process 502. Since unique product codes are generated for each item or package, a counterfeiter cannot generate authentic codes that will be authenticated due to the encryption algorithm used for code generation. As such, counterfeiters may copy valid codes from authentic products/packages and replicate onto counterfeit products. Therefore, duplicate authentication requests of a product code is monitored, according to one embodiment. During authentication of the product code, an identity of an authentication requester and time of authentication may be recorded. In addition, the location of the item can be recorded based on geographical data of the authentication of the product code of the item.

In one embodiment, in response to the quantity of authentication requests for the product code matching or exceeding a predetermined threshold, identifying the product code as a suspected duplicated. For example, in process 504, the quantity of authentication requests of the product code is compared to a predetermined threshold to indicate unauthorized duplication. In one embodiment, the predetermined threshold is based on at least one of a group comprising a type of product being authenticated, a location of product distribution and a location of the authentication request.

The quantity of authentication requests of the product code is tracked and recorded. The authentication record can be inspected and analyzed along with timing data of authentication requests to determine whether the product code has been duplicated. According to one embodiment, in response to the quantity of authentication requests for the product code matching or exceeding a predetermined threshold, the product code is selected to determine if the product code has been duplicated.

In one embodiment, when multiple authentication requests for a product code each having a same location, the multiple authentication requests are counted as a single authentication request. Similarly, multiple authentication requests for a product code generated by within a predetermined geographic distance of one another can be counted as a single authentication request. Further, the multiple authentication requests can be counted as a single authentication request when multiple authentication requests for a product code are received within a predetermined amount of time.

In addition, the multiple authentication requests can be counted as a single authentication request when multiple authentication requests for a product code are generated by a common requestor.

In another embodiment, the identities of the authentication requestors are classified into two or more groups and the groups include at least one of a customs official, law enforcement official, supply chain personnel, distributors, retailers, and end consumers. The determining the quantity of authentication requests of the product code for each of the two or more groups may occur separately and count against different thresholds.

In one embodiment, at least one predetermined threshold for the two or more groups is determined and the item for which the quantity of authentication requests for the product code matches or exceeds the at least one predetermined threshold is recorded.

In process 506, the item for which the quantity of authentication requests for the product code equals or exceeds the predetermined threshold is reported. In one embodiment, the item for which the quantity of authentication requests for the associated product code equals or exceeds at least one of the thresholds for the two or more groups is reported.

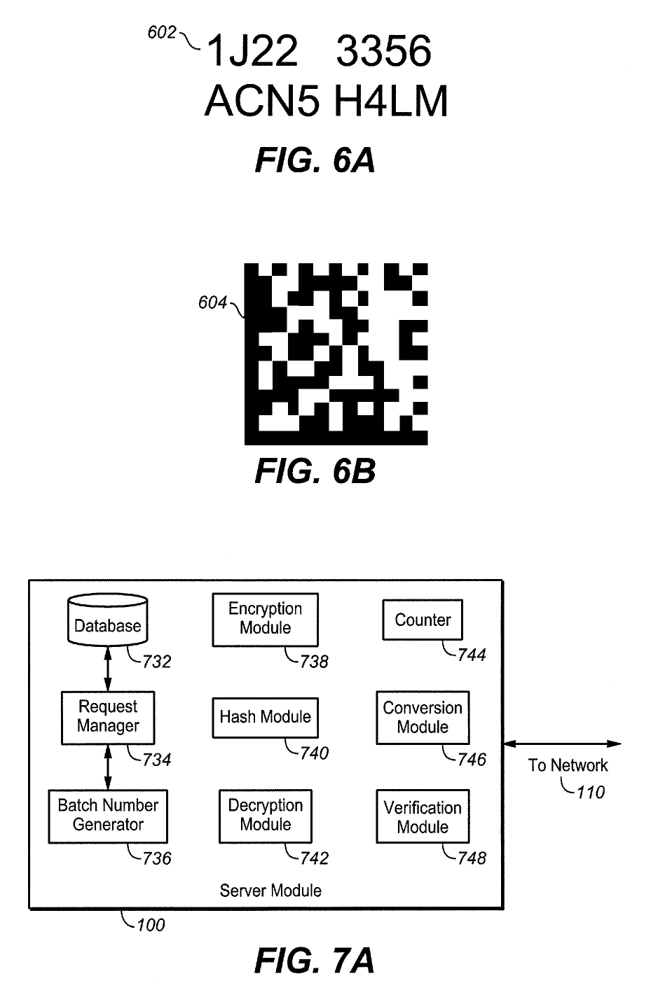

FIG. 6A illustrates an example of an alphanumeric representation of a product code, according to one embodiment. In one embodiment, the product code may be a string of sixteen alphanumeric characters consisting of numbers and letters, such as the product code 602. By utilizing different combinations of sixteen alphanumeric characters, more than a million, billion, billion (10²⁴) unique product codes may be generated. However, it will be appreciated by one skilled in the art that alternative embodiments of the invention may use a product code that is more or less than sixteen characters in length, and may use a product code that makes use of the entire set of ASCII characters.

FIG. 6B illustrates an example of an alphanumeric representation of a product code 604 encoded as a graphic symbol, according to one embodiment. In particular, the product code 604 is a special machine readable graphic symbol known as a datamatrix. A datamatrix is a two-dimensional matrix barcode consisting of black and white square modules arranged in either a square or rectangular pattern. Similar to a traditional barcode, a datamatrix can be read by a machine, such as a matrix barcode reader. Encoding an alphanumeric representation of the product code in a graphic symbol, such as the datamatrix 604, provides several advantages. First, error correction and redundancy are built-in to the datamatrix 604. Consequently, a product code represented as a datamatrix can still be read if it becomes partially damaged. Another advantage is the small footprint, or size, of the datamatrix. A datamatrix can encode as many as 50 characters in a three by three millimeter square, which can be discretely positioned on a product, a label, or product packaging. Finally, the datamatrix can be quickly and easily read by a machine.

Of course, it will be appreciated by those skilled in the art that in various alternative embodiments, product codes may be encoded with other graphic symbologies, for example, such as barcode fonts consistent with the PDF417 or QR Product code standards. In one embodiment, both versions of the product code 602 and 604 may be included on the product, label, or product packaging. For example, the alphanumeric representation of the product code 602 and the graphic symbol representation 604 may appear together on the product, label or product packaging. This provides a wide range of possible methods and mechanisms for reading and communicating the product code for authentication. In one embodiment, when extra security is required, the product codes may be applied or marked to the product, label, or product packaging in a covert manner, such that a consumer is not aware of the existence of the product code.

For example, the product codes may be applied to the products, labels or product packaging with a special invisible ink or other chemical-based application making the product code invisible to a consumer. According to the type of invisible ink or chemical used to apply the product code, reading the product code may require the application of heat, ultraviolet light, or a chemical. This approach may be utilized when someone in the supply or distribution chain other than the consumer is likely to be authenticating the product. For example, a covert product code may be provided for the purpose of authenticating products by customs officials.

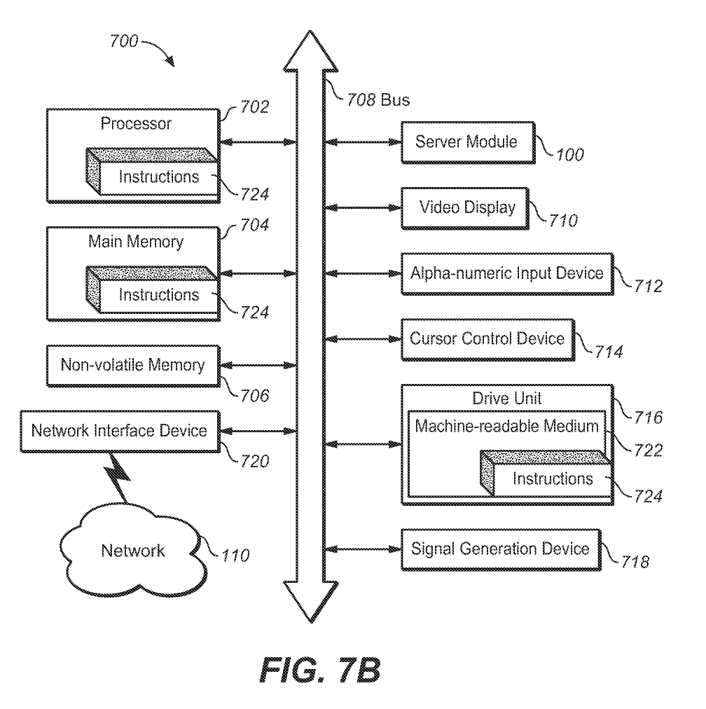

FIG. 7A is an exploded view of a server module 100, according to one embodiment. The server module may include a database 732, a request manager 734, a batch number generator 736, an encryption module 738, a hash module 740, a decryption module 742, a counter 744, a conversion module 746, and/or a verification module 748. In alternate embodiments, additional modules may be included, or less modules, or some modules on separate systems.

In one embodiment, the server module 100 receives a request for a batch of product codes, with each product code to be unique for a separate unit item. In one embodiment, the request manager 734 may process client requests for product code generation by initially assigning a key-ID for a new client or identifying a key-ID that has been previously assigned to an existing client in the database 732. In one embodiment, the key-ID is an identifier to an encryption key (e.g., a triple DES encryption key) that is used to encrypt the batch of product codes. The key-ID may be unique for a particular client, a specific customer, a manufacturing plant, and/or a production line. The key-ID may also be updated periodically, or after a predetermined number of usages.

In one embodiment, the database 732 maintains information about each key-ID of the client (customer) along with its associated encryption key. In alternate embodiments, the key-ID is associated with each product of a client. The update frequency of the key-ID can also be maintained in the database 732. It can also be envisioned that in some embodiments, a key-ID is not used to identify the encryption key for a particular client. The same encryption key may be used for each client.

In one embodiment, the database 732 also retains the product information associated with the plurality of product codes of the plurality of items. The product information includes one or more of details of security features of the item, the security features are covert or overt, a time attribute, a location attribute, a work order, a lot number, a manufacturing information, a use-by date, an operator name, a manufacturing plant, a universal product code (UPC), a product description, a package size, a quantity, a packaging image of the item, or a pre-identified destination of the item. According to one embodiment, the pre-identified destination of the item is identified by a country, city, state, province, zip code, street address, a home address, and/or a business address.

In one embodiment, information related to authentication of the plurality of product codes is also stored in the database 732. For example, the location of the item being authenticated may be recorded to determine if the location of the item being authenticated is consistent with the pre-identified destination of the item to detect product diversion. The item for which the number of inconsistent authentications (authentications where the location is different from the intended location) matches or exceeds a predetermined threshold can be reported.

In one embodiment, the predetermined threshold can be different for each client, product, and/or breadth of product distribution. For example, distribution of pharmaceuticals may be significantly more geographically confined than a household supply such as toothpaste due to different regulations in different parts of the world. Distribution of certain products may be illegal in some countries while legal in others. The above attributes contribute to at least partially determining the predetermined threshold of inconsistent authentications that constitutes suspected diversion activity. In one embodiment, identified locations of product code authentication located within a particular distance of the pre-identified destination of the product are considered to be consistent authentications and a product diversion alert is not triggered.

Furthermore, resale of products (e.g., a yard sale, an (online) auction, an online resale, etc.) may also result in product delivery to locations different from the original pre-identified destination of the product. Instances of product resale may be estimated and taken into account to determine the predetermined threshold. In alternate embodiments, the product code is used to track delivery of a product. If the product is lost during shipping (e.g., delivered to the wrong address), the product can be located by the shipper and/or the intended recipient. Additionally, product code authentication during shipment of a product can be taken into account. According to one embodiment, the transit route of the product is maintained in the database 732 and authentication during transit before arrival at the destination is not considered as an inconsistent authentication.

Since valid product codes cannot be counterfeited without knowledge of the encryption key, counterfeiters may replicate valid codes and mark them on alternate products or packages. Therefore, the quantity of authentication requests of a product code is recorded and stored in the database 732. The quantity of authentication requests of the product code is counted to track replication of valid product codes on to more than one item. The quantity of authentication requests can be compared to a predetermined threshold to determine counterfeiting activity due to product code duplication.

In one embodiment, an identity of the code authentication requester, the location of authentication, and the time of authentication is recorded and stored in the database 732. Additionally, the time interval between authentications of the same product codes may also be recorded. An algorithm determining the predetermined threshold takes into account at least some of the above stated factors. In one embodiment, multiple authentications of the same product code is monitored and analyzed based on the above indicated attributes of the authentications. For example, the same item may be authenticated twice when a distributor receives a product and when a consumer decides to purchase a product. Another instance of authentication may also occur when the consumer is about to use the product.

As such, authentications of the same product code performed under a particular set of circumstances may be considered as one instance based on one or more of an identity of an authentication requester, authentication time, authentication location. For example a single authentication request can comprise multiple requests having a same location of authentication request, multiple authentication requests having times of the authentication requests that are within a predetermined amount of time of each other or multiple authentication requests generated by the authentication requester having a same identity, or multiple authentication requests generated within a predetermined geographic distance of one another. In one embodiment, the identity of the code authentication requester is determined by an IP address, a phone number with an active user account, cookies on a browser, or a user name, etc.

The request manger 734 may communicate client information (e.g., product information including product name, lot number, production date, and/or line operator etc.) to the batch number generator 736. In one embodiment, the batch number corresponds to a batch of products that are produced in a predetermined unit of time, or a predetermined location.

For example, all toothpaste produced by Toothpaste Factory between 8 AM-11 AM may have one batch number and all toothpaste produced by Toothpaste Factory between 11 AM-1 PM may have another batch number. Additionally, toothpaste produced by Toothpaste Factory between 8 AM-11 AM at an alternate manufacturing site may yet have a different batch number. In one embodiment, each key-ID corresponds to a separate set of batch numbers.

For example, all Toothpaste Factory toothpaste may have one key-ID with different batch numbers dependent on time and place of manufacture. Alternatively, all Toothpaste Factory toothpaste manufactured at location A may have one key-ID and have different batch numbers depending on time of manufacture, and all Toothpaste Factory toothpaste manufactured at location B may have different batch number dependent on time of manufacture. In one embodiment, the database 732 retains information about each client and their associated batch number. The criterion used for batch number assignment (e.g., location based, time based, or a combination thereof, etc.) may also be stored in the database 732.

In one embodiment, a different batch number is used for each client if one encryption key is used for every client to avoid duplicate codes being generated. In one embodiment, an item number is a unique number assigned to each item of a particular batch of items having the same batch number. An item typically corresponds to a single product or a single package. In one embodiment, the item numbers may be sequential having increments of one. In alternate embodiments, the item numbers may be incremented or decremented in other units. In one embodiment, each batch number has a separate set of item numbers. Since information is retained about the batch number assignments in the database, the server module 100 may not retain item numbers, according to one embodiment.

In an alternate embodiment, an additional value (e.g., an alternate value) is used to associate multiple codes with one unit to avoid codes that contain potentially offensive or inappropriate words. In one embodiment, when a code is verified, the alternate value is ignored during the authentication process. In other words, codes having the same key-ID, batch number, and item number identify a same item even though they may have different alternate values.

In one embodiment, the counter 744 generates item numbers for a set of items with a particular batch number. The counter 744 may store the actual number of item numbers generated for the particular batch number and stored in the database as with the batch information.

In one embodiment, an alternate value may also be combined with the series of identifiers before encryption of the code. In a preferred embodiment, a triple-DES encryption algorithm (e.g., having 168 bit key length) is applied by the encryption module 738 to the combination of the series of identifiers. In alternate embodiments, other encryption algorithms may be applied. Since the check value is a predetermined constant value, a check value extracted from the decrypted code is compared to the expected value to determine authenticity of the code during the authentication process. In one embodiment, the check value is chosen to have a combination of zero bits and one bits to increase security of the encryption. Alternative check values may also be used.

In one embodiment, the encryption module 738 uses an encryption key to perform the triple DES encryption and each encryption key can be identified by the key-ID and may be stored in the database 732. In alternate embodiments, code providers at customer sites may also have access to their own encryption key.

In one embodiment, a version indicator can be used to support future versions of the coding algorithm. In the current embodiment, the version indicator having a value of zero is used. The value of one can be reserved for future use with alternate versions of the coding algorithm. In one embodiment, the version indicator and the key-ID can be combined into a word and obscured through computing a Boolean logic or arithmetic function (e.g., exclusive OR, NOR, AND, etc.) of the word and a hash of the encrypted value of the series of identifiers (e.g., a combination of the batch number, item number, and check value). In one embodiment, the hash can be computed by applying the Boolean logic or arithmetic function (e.g., exclusive OR, NOR, AND, etc.) between sub-words of the DES encrypted block by the hash module 740. One purpose of obscuring the key-ID and the version indicator allows codes to appear random.

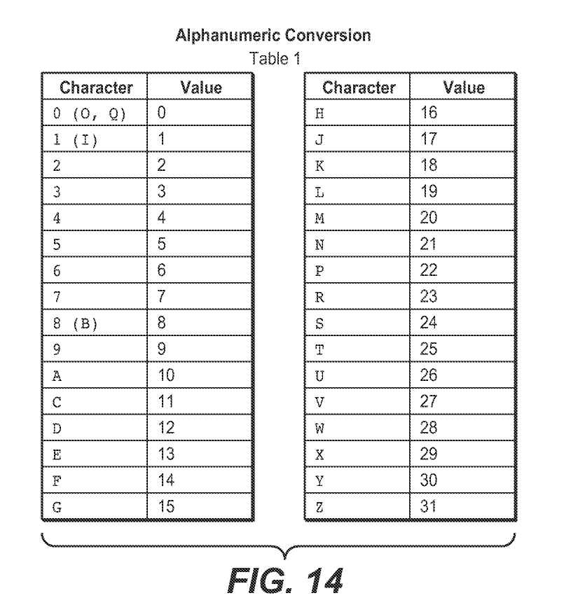

The encrypted code is a combination of the obscured value of the key-ID and version indicator with the encrypted value of the series of identifiers. In one embodiment, the encrypted code can be divided into smaller blocks (e.g., nibbles) and each block can be converted into an alphanumeric character by the conversion module 746. For example, each block may be converted into one of the thirty-two alphanumeric characters based a mapping illustrated in Table 1 of FIG. 14. In the embodiment shown in FIG. 14, the characters include the ten digits and twenty-two of the twenty-six upper case ASCII letters. In this embodiment, the letters O, Q I, and B are omitted to prevent confusion with the number digits 0, 1, and 8.

When a request for code authentication is received from a client, the conversion module 746 may also reference Table 1 to convert the alphanumeric representation to the original binary representation. Furthermore, during the authentication process, the decryption module 742 may use the encryption key identified through the key-ID extracted from the encrypted code to decrypt the encrypted code such that the check value can be extracted and compared to the expected value. In one embodiment, the verification module 748 compares the extracted batch number, and check value to expected values to determine validity of the encrypted code. Additionally, the verification module 748 may also compare the item number with the actual number of codes generated for a particular batch. If the item number equals or exceeds the total number of codes generated, then the code is determined invalid. In alternate embodiments, the check value may be a constant value used for one or more batches of codes.

It will be appreciated by one skilled in the art that the server module 100 illustrated in FIG. 2 has been provided as one example or embodiment of the disclosure, and is not meant to be limiting in nature. The module may include other logic and functional or modular components, the description of which has not been provided to avoid unnecessarily obscuring the invention.

FIG. 7B shows a diagrammatic representation of a machine in the exemplary form of a computer system 700 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server (e.g., the server module 100) or a client 102 machine in a client-server network environment, or as a peer machine in a peer-to-peer (or distributed) network environment. In one embodiment, the machine communicates with the server module 100 to facilitate operations of the server module and/or to access the operations of the server module.

The machine may be a server computer, a client computer, a personal computer (PC), a tablet PC, a set-top box (STB), a personal digital assistant (PDA), a cellular telephone, a web appliance, a network router, switch or bridge, or any machine capable of executing a set of instructions (sequential or otherwise) that specify actions to be taken by that machine. Furthermore, while only a single machine is illustrated, the term “machine” shall also be taken to include any collection of machines that individually or jointly execute a set (or multiple sets) of instructions to perform any one or more of the methodologies discussed herein.

The exemplary computer system 700 includes a processor 702 (e.g., a central processing unit (CPU) a graphics processing unit (GPU) or both), a main memory 704 and a nonvolatile memory 706, which communicate with each other via a bus 708. The computer system 700 may further include a video display unit 710 (e.g., a liquid crystal display (LCD) or a cathode ray tube (CRT)). The computer system 700 also includes an alphanumeric input device 712 (e.g., a keyboard), a cursor control device 714 (e.g., a mouse), a disk drive unit 716, a signal generation device 718 (e.g., a speaker) and a network interface device 720. The disk drive unit 716 includes a machine-readable medium 722 on which is stored one or more sets of instructions (e.g., software 724) embodying any one or more of the methodologies or functions described herein. The software 724 may also reside, completely or at least partially, within the main memory 704 and/or within the processor 702 during execution thereof by the computer system 700, the main memory 704 and the processor 702 also constituting machine-readable media. The software 724 may further be transmitted or received over a network 726 via the network interface device 720.

While the machine-readable medium 722 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

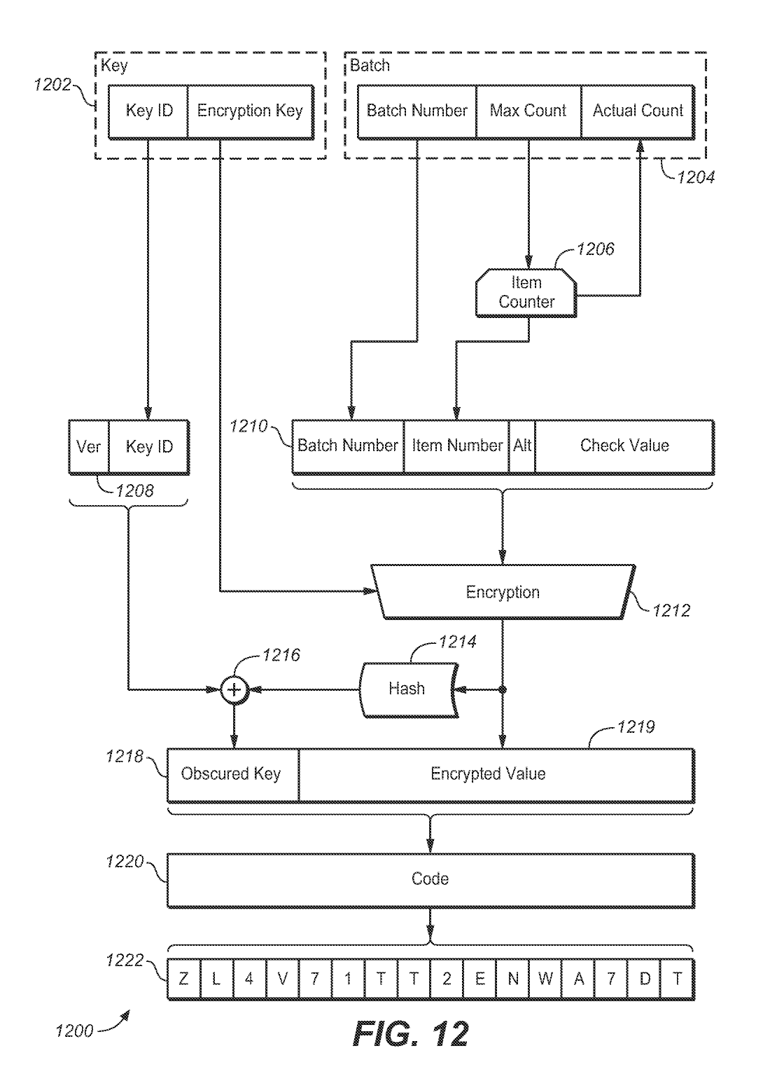

FIG. 12 is a block diagram illustrating a process 1200 of code generation and encryption, according to one embodiment.

When a request for a batch of codes is received, key information 1202 and batch information 1204 can be generated based on the client request. If the client is new, new key information and new batch information may be created based on coding needs of the new client. If the request is made by an existing client, existing key information 1202 and batch information 1204 may be retrieved and adjusted based on specific needs of the client (e.g., specific product line, specific manufacturing lot, specific version of an existing product, etc.).

In one embodiment, the key information includes a key-ID that identifies an encryption key and each client has a unique encryption key. In one embodiment, the key-ID is not maintained confidential since only the entity providing code generation services (e.g., server module 100) has access to the database linking the key-IDs to corresponding encryption keys.

In another embodiment, the same encryption key is used for each client. As such, the key information does not need to include the key-ID to identify an encryption key for a client since one encryption key is used for every client. Additionally, the batch numbers used for each client may be different (e.g., batches 1-5 for client A, and batches 10-15 for client B) so as to prevent same codes being generated for different clients.

In another embodiment, a predetermined number of encryption keys are used for a set of clients. The predetermined number of encryption keys used may be smaller than the number of clients. Rather than using a key-ID to identify an encryption key used, upon a request to authenticate a code, each of the encryption keys is used in an attempt to decode the code. If none of the decrypted values decrypted from each of the encryption keys yield the expected check value, then the code can be determined to be inauthentic. The decryption stops when one of the encryption codes is able decrypt a code to yield the expected check value or when the all the encryption codes have been used.

In one embodiment, the batch information 1204 may include a batch number, a maximum count of items, and an actual count of codes generated. The batch number and maximum count may be based on information sent by the client regarding their specific coding needs. The coding needs may be different for each product, each manufacturing site, each production date, etc. For example, a different batch number may be assigned for the same product but manufactured on different dates. The maximum count may be specified during the request based on the number of items that need coding. In one embodiment, the item counter 1206 sequentially generates an item number for each unit item and the number of actual codes generated (which may be less than the maximum count) is stored into the batch information 1204 as the actual count.

In one embodiment, a series of identifiers 1210 are combined where the series of identifiers include the batch number, the item number, an alternative value, and a check value. The check value is typically a known value that is predetermined and constant relative to a batch. In one embodiment, the series of identifiers 1210 is encrypted using an encryption algorithm (e.g., triple-key DES encryption) with the encryption key stored as the key information 1202. The encrypted value is shown as 1219. In one embodiment, the encrypting includes encrypting with multiple keys where the key includes multiple keys.

In another embodiment, to be able to authenticate the code, information about the key-ID is included in the code. For example, information about the key-ID may be included in the code using at least a portion of the encrypted code with the key-ID to generate an obscured key-ID to be included in the code. Using the at least a portion of the encrypted code may include computing a hash of the at least a portion of the encrypted code. In one embodiment, an obscured key-ID can be generated by performing an operation 1216 (e.g., a Boolean operation, an arithmetic operation and/or a binary operation, etc.) between the key-ID and a hash (e.g., 16 bit hash) of the encrypted value 1219.

The obscured key-ID can then be combined with the encrypted value 1219 to form a code 1220. In one embodiment, the code 1220 has 80 bits where 16 bits include information about the key-ID and 64 bits include the encrypted value 1219. The code 1220 may be separated into smaller blocks (e.g., nibbles of 5 bits) and each block is converted into an alphanumeric character for readability. In one embodiment, each nibble of 5 bits is converted to numbers or digits, such as the alphanumeric representation 1222 based on a mapping process illustrated in Table 1 of FIG. 14.

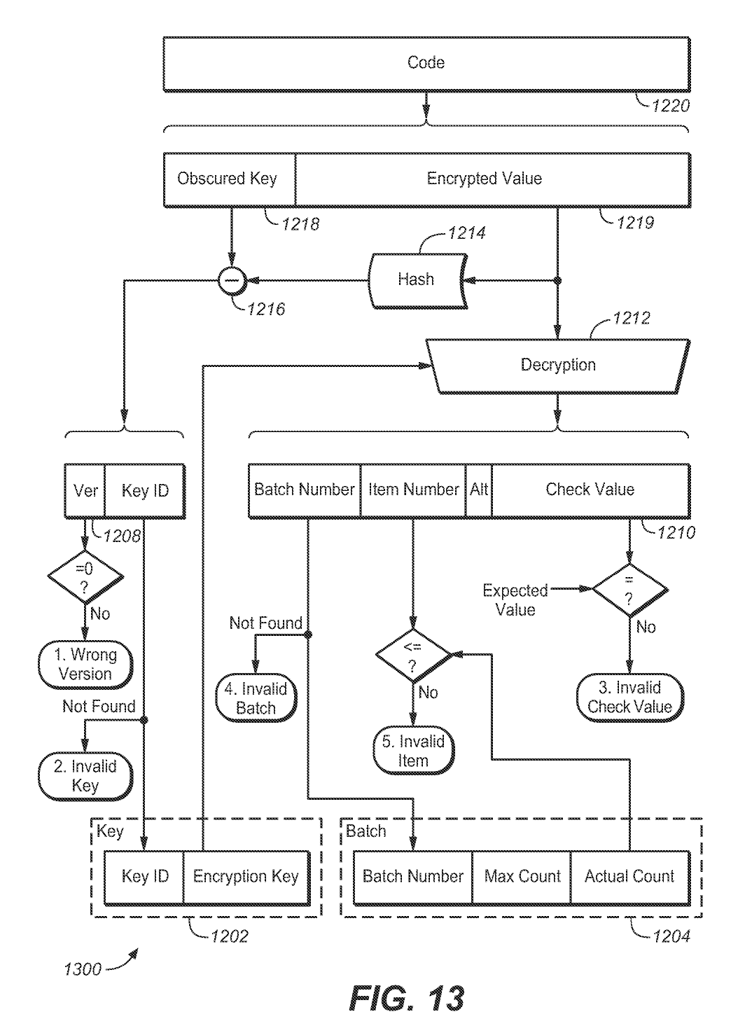

FIG. 13 is a block diagram illustrating a process 1300 of code verification, according to one embodiment.

When a code verification request is received, the alphanumeric representation of the code is first converted to its corresponding binary representation 1220 based on a mapping process illustrated in Table 1 of FIG. 14. Depending on how the alphanumeric representation was marked on a unit item, space characters and/or dashes in the alphanumeric representation may be removed prior to the conversion. In one embodiment, if the binary representation 1220 converted from the alphanumeric representation 1222 includes values that are not present in Table 1 of FIG. 14, the code is determined to be invalid. In one embodiment, if the number of characters of the alphanumeric representation received in the request is different from the expected number of characters, the code is determined to be invalid.

If all received characters are valid and the expected number of codes were received, the obscured key-ID and version indicator can be un-obscured through performing the function 1216 (e.g., boolean, arithmetic, and/or binary, etc.) on the obscured value with the hash 1214 of the encrypted value. In one embodiment, the recovered value 1208 includes a version indicator followed by the key-ID. In one embodiment, the obscured value 1218 is the first 16 bits of the code 1220 and the encrypted value is the latter 64 bits 1219 of the code 1220.

After the key-ID and the version indicator have been identified, the encryption key associated with the key-ID can be identified in a database (e.g., database 732 of the server module 100) of the coding service provider. In one embodiment, if a corresponding encryption key cannot be identified, the code is determined to be invalid. Since the key-ID was assigned through the coding service provider to clients, the coding service provider should have a record of key-IDs extracted from valid codes.

In one embodiment, if the encryption key corresponding to the key-ID is identified, the encrypted value 1219 (e.g., the latter 64 bits of the code 1220) is decrypted using the encryption key of the key information 1202. In one embodiment, a check value can be extracted from the decrypted block 1212 and compared to the expected value of the check value. If the extracted check value does not match the expected value, the code is determined to be invalid.

In one embodiment, a key-ID is not included in the code to identify an encryption key for the code. Rather, the same encryption key is used for each client. In another embodiment, a set of encryption keys is used. Rather than using a key-ID to identify the encryption key used to encrypt a particular code, each of the set of encryption keys is used to attempt to decrypt a code until the expected check value is extracted from the code. If none of the encryption keys can decrypt the code to yield an expected check value, the code can be determined to be inauthentic.

In addition, the batch number can also be extracted from the decrypted block 1210 to locate batch information 1204 that is associated with a particular product, manufacture lot, packaging site, etc. of the client. In one embodiment, if the batch number cannot be identified from the decrypted block 1210, the code is determined to be invalid. Furthermore, the item number can also be extracted from the decrypted block 1210. Since the batch information 1204 includes a count of the number of codes generated for a particular batch of items, the code is also determined to be invalid if the item number equals or exceeds the actual item count indicating tamper of the code production process to generate more codes than authorized.

FIG. 14 is an example conversion table for mapping encrypted product codes into an alphanumeric representation, according to one embodiment.

In one embodiment, the final product code of binary representation may be divided into smaller sized blocks (e.g., 16 of 5 bit nibbles) where each block is converted to an alphanumeric character to enhance readability and/or to minimize space required to mark a product code on a product packaging. In one embodiment, the conversion module 746 of the server module 100 of FIG. 7A reference the conversion table stored in the database 202 to perform the alphanumeric conversion. In one embodiment, each of the 5-bit nibbles is converted to one of 32 alphanumeric characters shown in Table 1 including ten digits and 22 upper case ASCII letters. The letters O, Q, B, and I are not used due to potential confusion with the digits 0, 1, and 8. During verification, the conversion module 746 may also reference Table 1 to map the alphanumeric representation of a product code received from a client back to the binary representation.

In general, the routines executed to implement the embodiments of the disclosure, may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

Although embodiments have been described with reference to specific exemplary embodiments, it will be evident that the various modification and changes can be made to these embodiments. Accordingly, the specification and drawings are to be regarded in an illustrative sense rather than in a restrictive sense. The foregoing specification provides a description with reference to specific exemplary embodiments. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A method comprising:
generating a plurality of product codes, each product code being unique for each separate item of a set of items;
recording a quantity of authentication requests for a product code of the plurality of product codes; and
in response to the quantity of authentication requests for the product code matching or exceeding a predetermined threshold, identifying the product code as a suspected duplicate.

2. The method of claim 1 further comprising recording at least one of an identity of an authentication requester, a location of an authentication request, and a time of the authentication request.

3. The method of claim 1 wherein the predetermined threshold is based on at least one of a group comprising a type of item associated with the product code being authenticated, a location of product distribution of the item associated with the product code being authenticated and the location of the authentication request.

4. The method of claim 2 wherein when multiple authentication requests for a product code each having a same location, the multiple authentication requests are counted as a single authentication request.

5. The method of claim 2 wherein when multiple authentication requests for a product code are received within a predetermined amount of time, the multiple authentication requests are counted as a single authentication request.

6. The method of claim 2 wherein when multiple authentication requests for a product code are generated by a common requester, the multiple authentication requests are counted as a single authentication request.

7. The method of claim 2 wherein when multiple authentication requests for a product code are generated within a predetermined geographic distance of one another, the multiple authentication requests are counted as a single authentication request.

8. The method of claim 2 wherein the identities of the authentication requestors are classified into two or more groups.

9. The method of claim 8 wherein the two or more groups comprise at least one of a group comprising customs official, law enforcement official, supply chain personnel, distributors, retailers, and end consumers.

10. The method of claim 8 further comprising separately determining the quantity of authentication requests of the product code for each of the two or more groups.

11. The method of claim 10 further comprising determining at least one predetermined threshold for each of the two or more groups and reporting the item for which the quantity of authentication requests for the product code matches or exceeds the at least one predetermined threshold.

12. A method comprising:
generating a plurality of product codes, each product code being unique for each separate item of a set of items;
identifying an expected destination for the set of items based on planned product shipments;
recording authentication locations of items of the set of items based on geographical data associated with authentication requests of the plurality of product codes associated with the set of items; and
in response to identifying a pre-identified quantity or percentage of the authentication locations being different from the expected destination of the set of items, identifying the set of items as possibly having been diverted.

13. The method of claim 12 wherein the geographical data is at least one of a group comprising a zip code, a country code, an area code, an IP address, a telephone number, GPS data, a satellite image, or a physical address associated with the authentication request.

14. The method of claim 13 wherein the geographical data is determined from at least one of a group comprising an identity of an authentication requester, a location of the authentication request, account information of a requesting device with a service provider, a unique identifier of the authentication request, or a unique identifier of the requesting device.

15. A machine readable media having stored thereon a set of instructions, which when executed cause a machine to perform a method comprising:
generating a plurality of product codes, each product code being a unit level code that is unique for each item of a set of items;
recording a quantity of authentication requests for a product code of the plurality of product codes; and
in response to the quantity of authentication requests for the product code matching or exceeding a predetermined threshold, identifying the product code as a suspected duplicated.

16. A machine readable media having stored thereon a set of instructions, which when executed cause a machine to perform a method comprising:
generating a plurality of product codes, each product code being unique for each separate item of a set of items;
identifying an expected destination for the set of items based on planned product shipments;
recording authentication locations of items of the set of items based on geographical data associated with authentication requests of the plurality of product codes associated with the set of items; and
in response to identifying a pre-identified quantity or percentage of the authentication locations being different from the expected destination of the set of items, identifying the set of items as possibly having been diverted.

17. A system comprising:
a unit to generate a plurality of product codes, each product code being a unit level code that is unique for each item of a set of items;
a unit to record a quantity of authentication requests for a product code of the plurality of product codes; and
a unit to identify the product code as a suspected duplicated, in response to the quantity of authentication requests for the product code matching or exceeding a predetermined threshold.

18. A system comprising:
a unit to generate a plurality of product codes, each product code being unique for each separate item of a set of items;
a unit to identify an expected destination for the set of items based on planned product shipments;
a unit to record authentication locations of items of the set of items based on geographical data associated with authentication requests of the plurality of product codes associated with the set of items; and
a unit to identify the set of items as possibly having been diverted, in response to identifying a pre-identified quantity or percentage of the authentication locations being different from the expected destination of the set of items.
